(19) United States
(12) Patent Application Publication
(10) Pub. No.: US 2025/0046916 A1
(43) Pub. Date: Feb. 6, 2025

(54) LAMINATE FILM, BATTERY CELL, AND BATTERY MODULE

(71) Applicant: TOYOTA JIDOSHA KABUSHIKI KAISHA, Toyota-shi (JP)

(72) Inventors: Tomoya MESUDA, Nisshin-shi (JP); Seigo FUJISHIMA, Miyoshi-shi (JP); Yoshiro OBAYASHI, Toyota-shi (JP); Kosuke SUZUKI, Toyota-shi (JP); Takeru HARA, Toyota-shi (JP); Satoshi MORIYAMA, Nagoya-shi (JP); Kenta MIYAHARA, Toyohashi-shi (JP)

(73) Assignee: TOYOTA JIDOSHA KABUSHIKI KAISHA, Toyota-shi (JP)

(21) Appl. No.: 18/636,501

(22) Filed: Apr. 16, 2024

(30) Foreign Application Priority Data
Aug. 3, 2023 (JP) 2023-126970

(51) Int. Cl. H01M 50/105; B60L 50/64; H01M 50/211

(52) U.S. Cl. CPC H01M 50/105; B60L 50/64; H01M 50/211; H01M 2220/20

(57) ABSTRACT

The laminate film includes an accommodating portion for accommodating the electrode body, and seals the electrode body in the accommodated state. The accommodating portion has a side wall portion facing the peripheral end face of the electrode body, and an uneven portion is provided on at least a part of the side wall portion.

### CROSS-REFERENCE TO RELATED APPLICATION

This application claims priority to Japanese Patent Application No. 2023-126970 filed on Aug. 3, 2023, incorporated herein by reference in its entirety.

### BACKGROUND

### 1. Technical Field

The disclosure relates to a laminate film, a battery cell, and a battery module.

### 2. Description of Related Art

Japanese Unexamined Patent Application Publication No. 2006-49054 (JP 2006-49054 A) discloses a sheet material type battery (battery cell) that is made up by wrapping an electrode body with a sheet material (laminate film). In the sheet material type battery described in JP 2006-49054 A, the electrode body is interposed between uneven plate materials, and the uneven plate materials are covered with the sheet material. Thus, surfaces of the sheet material type battery become uneven, and heat dissipation characteristics are ensured.

### SUMMARY

However, in the sheet material type battery described in JP 2006-49054 A above, both faces thereof are formed in uneven forms, and accordingly there is room for improvement in bettering stacking properties when a plurality of batteries is accommodated in a case and modularized.

In view of the above circumstances, it is an object of the disclosure to provide a laminate film, a battery cell, and a battery module, in which stacking properties are secured while suppressing thermal expansion, in a laminate film accommodating an electrode body.

A laminate film according to a first aspect includes an accommodating portion for accommodating an electrode body, the laminate film being sealed in a state in which the electrode body is accommodated.

The accommodating portion includes a side wall portion facing a peripheral end face of the electrode body, and an uneven portion is provided on at least a part of the side wall portion.

In the laminate film according to the first aspect, the accommodating portion for accommodating the electrode body is provided, and the accommodating portion includes the side wall portion facing the peripheral end face of the electrode body. Now, the uneven portion is formed on at least part of the side wall portion, and accordingly even when gas is generated by repeated charging and discharging, the uneven portion expands and contracts, and thermal expansion can be suppressed.

Also, fabricating a portion of the accommodating portion facing a principal face of the electrode body to have a form such that these do not interfere with each other, enables stacking properties to be secured by bringing adjacent laminate films into surface contact when modularizing.

In the laminate film according to a second aspect, in the first aspect, the accommodating portion may include a bottom wall portion opposed to a principal face of the electrode body, and the bottom wall portion may be planar, with no unevenness.

In the laminate film according to the second aspect, the bottom wall portion facing the principal face of the electrode body is formed in planar form, and accordingly stacking properties can be improved by arraying battery cells so that the principal faces overlay each other.

A battery cell according to a third aspect includes an electrode body, in which a cathode, an anode, and a separator are laminated, and the laminate film according to the second aspect, accommodating the electrode body.

The battery cell according to the third aspect has the same operation as that of the second aspect.

A battery module according to a fourth aspect includes
a case, in which is accommodated a plurality of the battery cells according to the third aspect in an arrayed state.

The battery cells are disposed such that the bottom wall portions of the battery cells that are adjacent to each other face each other.

In the battery module according to the fourth aspect, the battery cells accommodated in the case are arrayed such that the bottom wall portions thereof face each other, and accordingly uneven portions thereof do not interfere with each other.

As described above, according to the laminate film, the battery cell, and the battery module, of the disclosure, stacking properties are secured while suppressing thermal expansion in the laminate film accommodating the electrode body.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view illustrating a main part of a vehicle to which a battery pack according to an embodiment is applied;

FIG. 2 is a schematic perspective view of a battery module;

FIG. 3 is a plan view of the battery module with an upper lid removed;

FIG. 4 is a schematic view of a battery cell accommodated in a battery module as viewed from a thickness direction;

FIG. 5 is a schematic cross-sectional view of a battery cell in an embodiment;

FIG. 6 is a schematic cross-sectional view of a laminate film prior to sealing in an embodiment;

FIG. 7 is a schematic cross-sectional view of a battery cell according to a modification; and

FIG. 8 is a schematic cross-sectional view of a laminate film before sealing in a modification.

### DETAILED DESCRIPTION OF EMBODIMENTS

The battery module 11 to which the laminate film 22 according to the embodiment is applied will be described with reference to the drawings.

### Overall Configuration of Vehicle 100

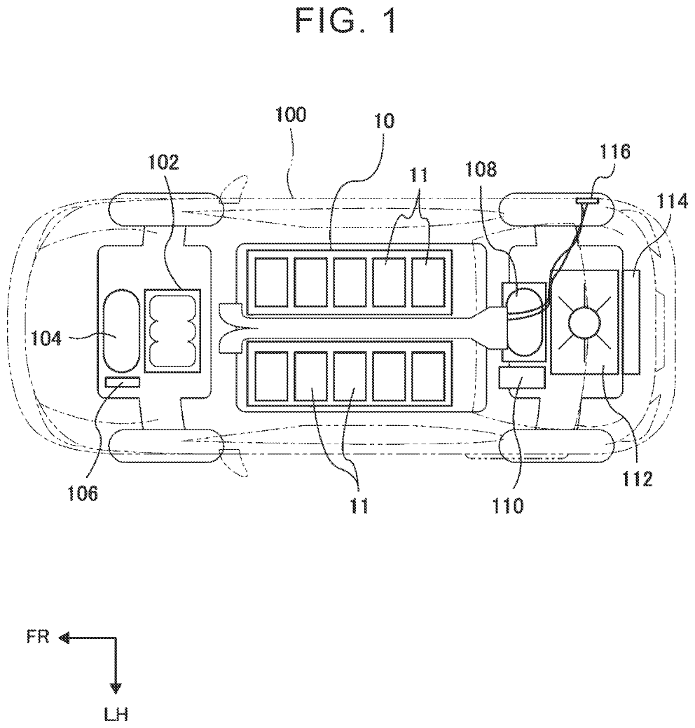

FIG. 1 is a schematic plan view showing a main part of a vehicle 100 to which a battery pack 10 according to an embodiment is applied. As illustrated in FIG. 1, the vehicles 100 are battery electric vehicle (BEV) in which the battery packs 10 are mounted under the floor. Note that the arrows UP, the arrow FR, and the arrow LH in the drawings respectively indicate the upper side in the vehicle up-down direction, the front side in the vehicle front-rear direction, and the left side in the vehicle widthwise direction. In the case where the description is made using the front, rear, left, right, and up and down directions, the front and back directions in the vehicle front-rear direction, the left and right directions in the vehicle width direction, and the up and down directions in the vehicle vertical direction are shown unless otherwise specified.

In the vehicle 100 of the present embodiment, DC/DC converters 102, the electric compressors 104, and Positive Temperature Coefficient (PTC) heaters 106 are arranged in front of the vehicle relative to the battery pack 10. Further, a motor 108, a gear box 110, an inverter 112, and a charger 114 are disposed on the vehicle rear side of the battery pack 10.

The DC current outputted from the battery pack 10 is regulated by DC/DC converters 102 and then supplied to the electric compressor 104, PTC heaters 106, the inverters 112, and the like. Further, electric power is supplied to the motor 108 via the inverter 112, so that the rear wheels rotate to drive the vehicle 100.

A charging port 116 is provided on the right side portion of the rear portion of the vehicle 100, and electric power can be stored in the battery pack 10 via the in-vehicle charger 114 by connecting a charging plug of an external charging facility (not shown) from the charging port 116.

Note that the arrangement, structure, and the like of the components constituting the vehicle 100 are not limited to the above-described configurations. For example, the present embodiment may be applied to an engine-mounted hybrid electric vehicle (HV) or plug-in hybrid electric vehicle (PHEV). In the present embodiment, the motor 108 is a rear-wheel-driven vehicle mounted on the rear portion of the vehicle, but the present disclosure is not limited thereto. In the present embodiment, the motor 108 may be a front wheel drive vehicle mounted on a front portion of the vehicle, or a pair of motors 108 may be mounted on the front and rear of the vehicle. Further, the present embodiment may be a vehicle including an in-wheel motor for each wheel.

Here, the battery pack 10 includes a plurality of battery modules 11. In the present embodiment, as an example, ten battery modules 11 are provided. Specifically, five battery modules 11 are arranged in the vehicle front-rear direction on the right side of the vehicle 100, and five battery modules 11 are arranged in the vehicle front-rear direction on the left side of the vehicle 100. The battery modules 11 are electrically connected to each other.

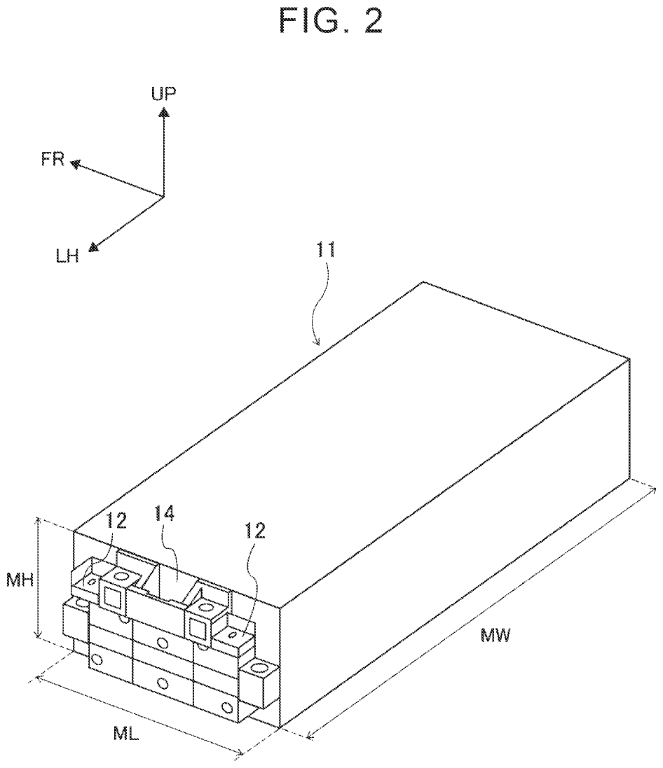

FIG. 2 is a schematic perspective view of the battery module 11. As shown in FIG. 2, the battery module 11 is formed in a substantially rectangular parallelepiped shape whose longitudinal direction is the vehicle width direction. The outer shell of the battery module 11 is made of an aluminum alloy. For example, an outer shell of the battery module 11 is formed by joining aluminum die-casting to both ends of an extruded material of an aluminum alloy by laser welding or the like.

A pair of voltage terminals 12 and a connector 14 are provided at both end portions of the battery module 11 in the vehicle width direction, respectively. A flexible printed circuit board 21, which will be described later, is connected to the connector 14. A bus bar (not shown) is welded to both end portions of the battery module 11 in the vehicle width direction.

The length MW of the battery module 11 in the vehicle width direction is, for example, 600 mm from 350 mm, the length ML in the vehicle front-rear direction is, for example, 250 mm from 150 mm, and the height MH in the vehicle vertical direction is, for example, 110 mm from 80 mm.

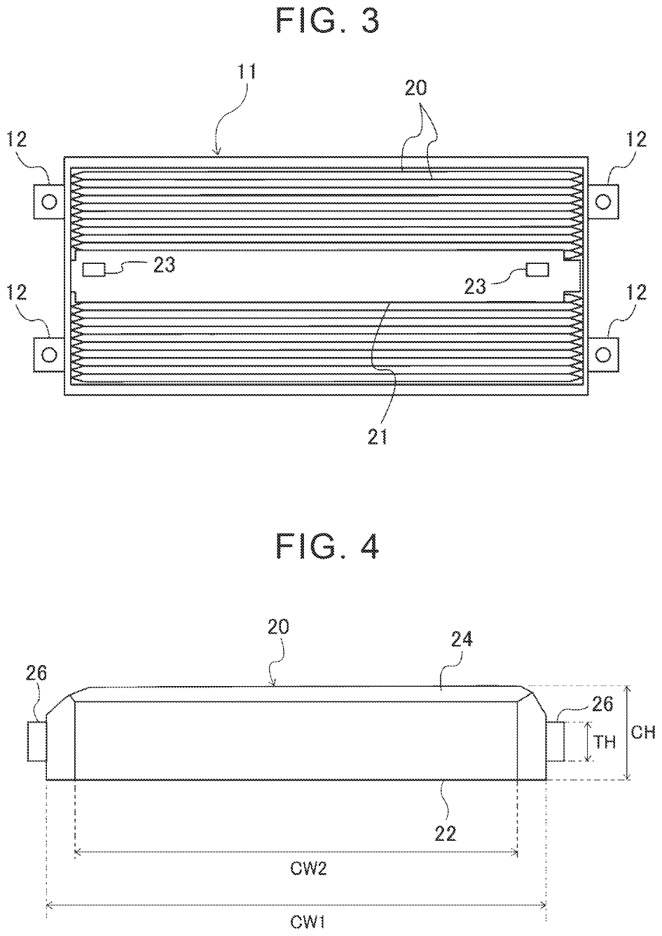

FIG. 3 is a plan view of the battery module 11 with the upper lid removed. As shown in FIG. 3, a plurality of battery cells 20 are accommodated in the battery module 11 in an arranged state. In the present embodiment, as an example, 24 battery cells 20 are arranged in the vehicle front-rear direction and adhered to each other.

A Flexible Printed Circuit (FPC) 21 is disposed on the battery cell 20. The flexible printed circuit board 21 is formed in a band shape with the vehicle width direction as a longitudinal direction. Thermistors 23 are provided at both ends of the flexible printed circuit board 21. The thermistor 23 is not adhered to the battery cell 20 and is pressed toward the battery cell 20 by the upper lid of the battery module 11.

One or a plurality of cushioning materials (not shown) are accommodated in the battery module 11. For example, the cushioning material is an elastically deformable thin plate-shaped member, and is disposed between the adjacent battery cells 20 with the arrangement direction of the battery cells 20 as the thickness direction. In the present embodiment, as an example, cushioning materials are disposed at both end portions in the longitudinal direction of the battery module 11 and at a central portion in the longitudinal direction, respectively.

FIG. 4 is a schematic view of the battery cell 20 accommodated in the battery module 11 viewed from the thickness direction. As shown in FIG. 4, the battery cell 20 is formed in a substantially rectangular plate shape, and an electrode body (not shown) is accommodated therein. The electrode body is formed by laminating a cathode, an anode, and a separator, and is sealed with a laminate film 22.

In the present embodiment, as an example, the embossed sheet-like laminate film 22 is folded and bonded to form an accommodating portion of the electrode body. Although both of the single-cup embossing structure in which the embossing is performed at one place and the double-cup embossing structure in which the embossing is performed at two places can be adopted, in the present embodiment, the single-cup embossing structure has a depth of draw of about 10 mm from the drawing depth 8 mm.

The upper ends of both end portions in the longitudinal direction of the battery cell 20 are bent, and the corners have an outer shape. Further, the upper end portion of the battery cell 20 is bent, and the fixing tape 24 is wound around the upper end portion of the battery cell 20 along the longitudinal direction.

Here, terminals (tabs) 26 are provided at both ends in the longitudinal direction of the battery cell 20. In the present embodiment, as an example, the terminal 26 is provided at a position offset downward from the center of the battery cell 20 in the vertical direction. The terminal 26 is joined to a bus bar (not shown) by laser welding or the like.

The vehicle-width-direction length CW1 of the battery cells 20 is, for example, 530 mm to 600 mm. The length CW2 of the area in which the electrode body of the battery cell 20 is accommodated is, for example, 500 mm to 520 mm. The height CH of the battery cell 20 is, for example, 80 mm to 110 mm. The battery cell 20 has a thickness of 7.0 mm to 9.0 mm. The height TH of the terminal 26 is 40 mm to 50 mm.

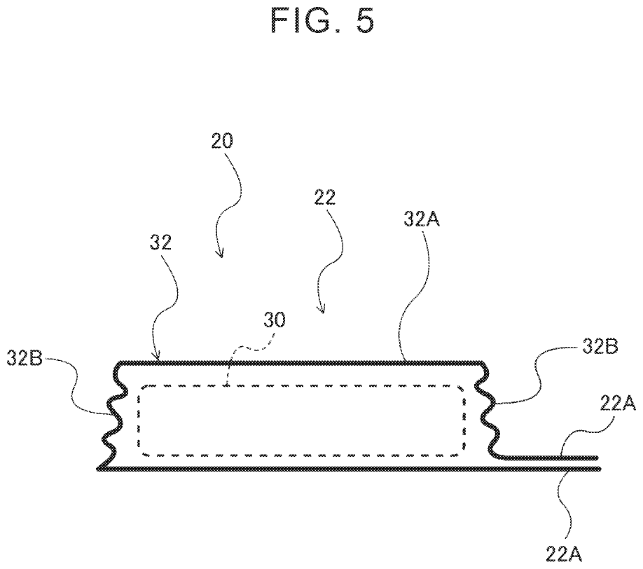

FIG. 5 is a schematic cross-sectional view of the battery cell 20 according to the embodiment. As shown in FIG. 5, the battery cell 20 of the present embodiment includes an electrode body 30 formed by laminating a cathode, an anode, and a separator, and a laminate film 22 accommodating the electrode body 30. The electrode body 30 constitutes, for example, a lithium ion battery, and lithium cobaltate, lithium nickelate, lithium manganate, and the like are used as the active material of the cathode. As the active material of the anode, graphite, lithium titanate, or the like is used. Further, the battery cell 20 is filled with an electrolytic solution.

The laminate film 22 includes an accommodating portion 32 that houses the electrode body 30, and is sealed in a state where the electrode body 30 is housed in the accommodating portion 32.

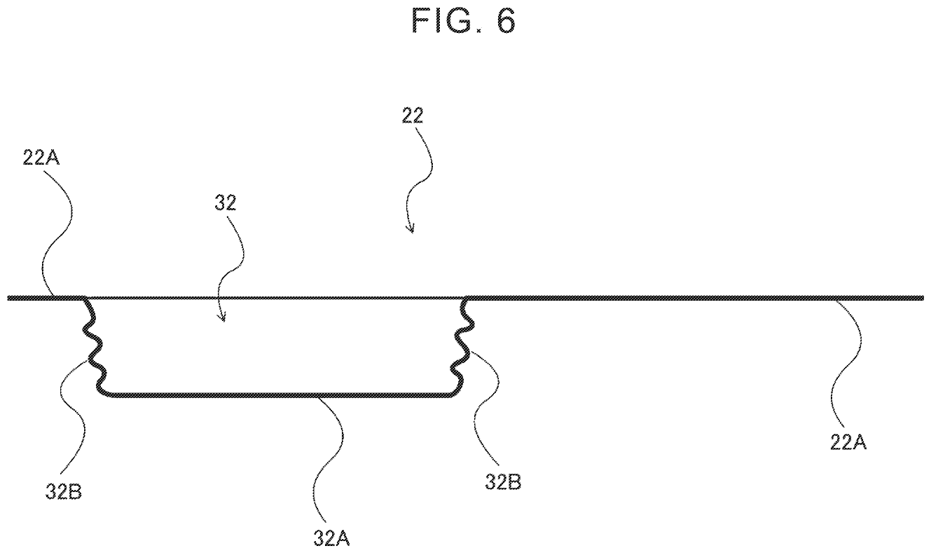

FIG. 6 is a schematic cross-sectional view of the laminate film 22 prior to sealing in an embodiment. As shown in FIG. 6, the laminate film 22 before sealing includes a concave portion formed by embossing or the like, and the accommodating portion 32 is formed by the concave portion. Further, the periphery of the recessed portion (accommodating portion 32) is a seal portion 22A formed in a sheet shape, and in this seal portion 22A, the stacked laminated films 22 are welded to each other.

Here, the accommodating portion 32 includes a bottom wall portion 32A and a side wall portion 32B. The bottom wall portion 32A is a portion facing the principal face of the electrode body 30, and adjacent battery cells are disposed to face each other with the bottom wall portion 32A facing each other when the battery module 11 is configured.

The side wall portion 32B is a portion of the accommodating portion 32 facing the peripheral end face of the electrode body 30, and is formed in an uneven shape. For example, after the accommodating portion 32 is formed by embossing, only the side wall portion 32B is formed in an uneven shape by pressing. For this reason, the bottom wall portion 32A is formed in a planar shape having no irregularities.

### Action

Next, the operation of the laminate film 22 according to the present embodiment will be described.

The laminate film 22 according to the present embodiment includes an accommodating portion 32 that houses the electrode body 30, and the accommodating portion 32 includes a side wall portion 32B that faces the peripheral end face of the electrode body 30. Here, since the uneven portion is formed in at least a part of the side wall portion 32B, even when the charging and discharging are repeated and the gases are generated, the uneven portion expands and contracts to suppress thermal expansion of the battery cell 20.

Further, by making the bottom wall portion 32A facing the principal face of the electrode body 30 in the accommodating portion 32 to be a flat surface, the flat surfaces of the laminated films 22 adjacent to each other at the time of modularization are brought into contact with each other, the uneven portions does not interfere with each other, it is possible to secure the stacking property.

In particular, since the battery cells 20 of the present embodiment are arranged such that the bottom wall portions 32A face each other in the battery module 11, the uneven portions do not need to interfere with each other.

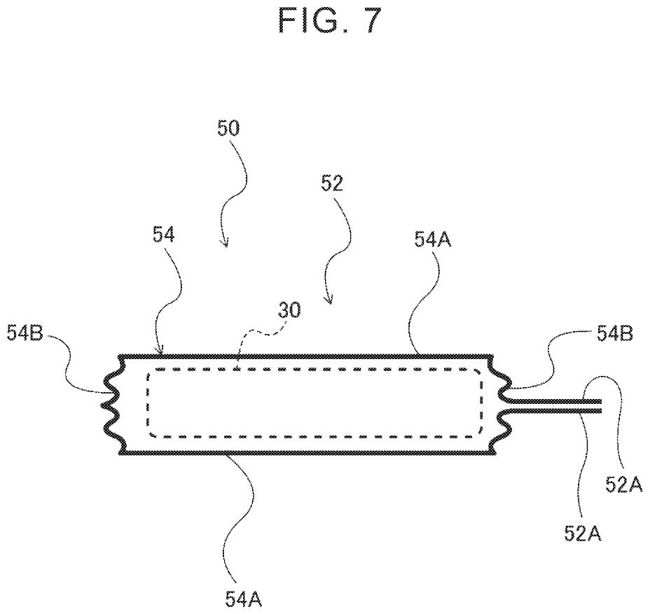

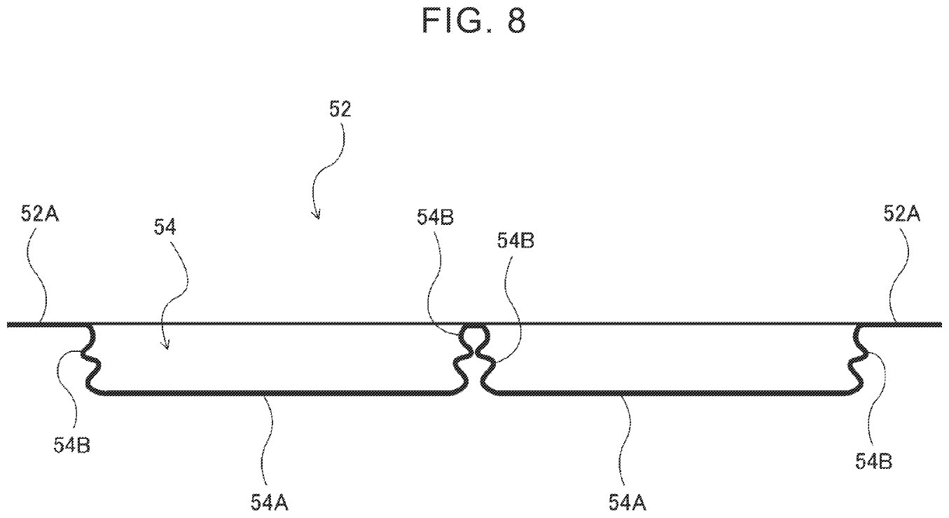

In the above-described embodiment, a single-cup embossing structure in which one concave portion is embossed in the laminate film 22 is employed, but the present disclosure is not limited thereto, and a double-cup embossing structure shown in FIGS. 7 and 8 may be employed.

### Modification

FIG. 7 is a schematic cross-sectional view of the battery cell 50 in the modification example, and FIG. 8 is a schematic cross-sectional view of the laminate film 52 before sealing in the modification example. As illustrated in FIG. 7, a battery cell 50 according to the present modification includes an electrode body 30 and a laminate film 52 that accommodates the electrode body 30.

The laminate film 52 includes an accommodating portion 54 for accommodating the electrode body 30, and is sealed in a state in which the electrode body 30 is accommodated in the accommodating portion 54.

As shown in FIG. 8, the laminate film 52 before sealing includes two recesses formed by embossing or the like, and these recesses are superposed to form the accommodating portion 54. Further, the periphery of each recess (accommodating portion 54) is a seal portion 52A formed in a sheet shape, in this seal portion 52A, the laminated films 52 which are superimposed are welded to each other.

Here, each of the recesses constituting the accommodating portion 54 includes a bottom wall portion 54A and a side wall portion 54B. The bottom wall portion 54A is a portion opposed to the principal face of the electrode body 30, and adjacent battery cells are disposed so as to face each other in the bottom wall portion 54A when the battery module is configured.

The side wall portion 54B is a portion of the accommodating portion 54 facing the peripheral end face of the electrode body 30, and is formed in an uneven shape. For example, after the accommodating portion 54 is formed by embossing, only the side wall portion 54B is formed in an uneven shape by pressing. For this reason, the bottom wall portion 54A is formed in a planar shape having no irregularities.

According to the present modification, by adopting the double cup embossing structure, it is possible to accommodate even when the thickness of the electrode body 30 is large.

Although the laminate film 22, the battery cell 20, and the battery module 11 according to the present embodiment have been described above, the present disclosure is not limited thereto and can be implemented in various forms without departing from the gist of the present disclosure. For example, in the above-described embodiment, the whole of the four side wall portions 32B constituting the accommodating portion 32 is formed in an uneven shape, but the present disclosure is not limited thereto, and only a part of the side wall portions 32B may be formed in an uneven shape.

In the above embodiment, the bottom wall portion 32A is formed in a planar shape, but the present disclosure is not limited thereto. For example, a plurality of recesses may be formed in the bottom wall portion 32A. In this case, thermal expansion can be suppressed without interference between adjacent battery cells.

Further, in the above-described embodiment, the side wall portion 32B is seen from the side surface, and the substantially corrugated uneven portion is formed, but the present disclosure is not limited thereto. For example, a substantially corrugated concavo-convex portion may be formed as viewed from the bottom wall portion 32A. That is, the uneven shape is not limited.

With respect to the above embodiments, the following supplementary notes are disclosed.

### Appendix 1

A laminate film comprising an accommodating portion for accommodating an electrode body and sealing in a state of accommodating the electrode body,

A laminate film in which an uneven portion is formed on at least a part of a side wall portion facing a peripheral end face of the electrode body in the accommodating portion.

### Appendix 2

The laminate film according to claim 1, wherein in the accommodating portion, a bottom wall portion opposed to a principal face of the electrode body is formed in a flat shape without irregularities.

### Appendix 3

an electrode body, in which a cathode, an anode, and a separator are laminated, and
The laminate film according to Appendix 1 or 2 for accommodating the electrode body,
A battery cell comprising:

### Additional Remark 4

A case is provided with a plurality of battery cells described in Appendix 3 accommodated in an arranged state,

In the plurality of battery cells, the adjacent battery cells face each other with the bottom wall portion facing each other.

What is claimed is:

1. A laminate film, comprising an accommodating portion for accommodating an electrode body, the laminate film being sealed in a state in which the electrode body is accommodated, wherein the accommodating portion includes a side wall portion facing a peripheral end face of the electrode body, and an uneven portion is provided on at least a part of the side wall portion.

2. The laminate film according to claim 1, wherein the accommodating portion includes a bottom wall portion opposed to a principal face of the electrode body, and the bottom wall portion is planar, with no unevenness.

3. A battery cell, comprising:
an electrode body, in which a cathode, an anode, and a separator are laminated; and
the laminate film according to claim 2, accommodating the electrode body.

4. A battery module, comprising a case, in which is accommodated a plurality of the battery cells according to claim 3 in an arrayed state, wherein the battery cells are disposed such that the bottom wall portions of the battery cells that are adjacent to each other face each other.
